(19) United States
(12) Patent Application Publication
(10) Pub. No.: US 2009/0159513 A1
(43) Pub. Date: Jun. 25, 2009

(54) GRAVITY SEPARATOR

(75) Inventors: Erich Kohl, Meerbusch (DE); August van der Beek, Grevenbroich (DE)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Metso USA Inc.

(21) Appl. No.: 12/267,662

(22) Filed: Nov. 10, 2008

(30) Foreign Application Priority Data
Dec. 22, 2007 (DE) 10 2007 062 341.2

(51) Int. Cl. B07B 7/01; B07B 13/16

(52) U.S. Cl. 209/698

(57) ABSTRACT

The invention relates to a gravity separator having the following features:

a channel-like portion having a transport unit, along which a material to be classified can be transported from a feeding end to a classification chamber, a closure unit which is arranged on and/or in the channel-like portion, the closure unit can be moved perpendicularly relative to the transport direction of the material to be classified and is arranged in such a manner that it rests on the material which is transported through with at least a portion.

### FIELD OF THE INVENTION

The invention relates to a gravity separator.

### BACKGROUND OF THE INVENTION

Gravity separators are classifying machines from the screening group. Gravity separators (gravitation sizers) have “uniaxial or one-dimensional” flow fields. This applies to both so-called ascending separators and horizontal separators.

The prior art and the invention are illustrated below with reference to ascending separators, in particular up-current separators (counterflow separators), without limiting the invention in this regard.

In the case of up-current separators, the separation material (the material to be classified) is conveyed by means of a transport unit at a specific angle relative to the flow direction of the carrier medium (in most cases air) to a classification chamber which extends in a substantially vertical manner.

One problem is that, together with the material to be classified, external air (secondary air) reaches the classification chamber and inhibits the air separation in the classification chamber. The quality of the level of separation, for example, of light and heavy material, decreases accordingly.

Attempts have been made to reduce the intake of external air by means of flaps or curtains along the transport path of the material to be classified. However, devices of this type have the disadvantage that they become damaged, jammed or disrupt a regular supply of material in another manner, for example, when crushed waste material is fed into the separator.

This is particularly the case with separators for separating residual materials from different sources, these residual materials previously being shredded if necessary. Residual materials include, for example, mixed waste as occurs in the preparation of scrap cars. Mixed waste contains, for example, metal components, but also plastics components such as upholstery of car seats, etcetera.

### SUMMARY OF THE INVENTION

The object of the invention is to provide a gravity separator of the type mentioned in which as little external air as possible enters the classification chamber when the material is fed in, in order to thus improve the degree of separation of the material to be classified.

The invention makes use of the notion known in principle of incorporating in the supply path for the material to be classified a type of “air block” which is referred to below as a closure unit, but with this closure unit being intended to be able to be moved substantially perpendicularly relative to the transport direction of the material to be classified. The movement direction of the closure unit being normal relative to the delivery transport plane for the material to be classified reliably prevents the material and the closure unit from becoming jammed.

At the same time, this allows a second aspect of the invention to be implemented, that is to say, achieving more or less continuous contact between the closure unit and the flow of the material which is transported through. This is important in order to keep any potential free space between the material to be classified and the environment in the region of the channel-like portion as small as possible and consequently to minimise the flow cross-section with respect to an influx of external air.

The invention is therefore directed on the one hand to construct the closure unit in such a manner that it rests on the flow of material or is guided over the flow of material as continuously as possible and, on the other hand, also to achieve a sealing with respect to the surrounding machine components, in particular the channel-like portion, along which the material to be classified is supplied.

In its most general embodiment, the invention relates to a gravity separator having the following features:

a channel-like portion having a transport unit, along which a material to be classified can be transported from a feeding end to a classification chamber,

a closure unit which is arranged on and/or in the channel-like portion,

the closure unit can be moved perpendicularly relative to the transport direction of the material to be classified and is arranged in such a manner that it rests on the material which is transported through with at least one portion.

In one configuration, there is provision for the closure unit to roll on the material which is transported through. This can advantageously be achieved by means of a roller-like member. Such a roller may be arranged with the axis thereof transversely relative to the transport direction of the material to be classified and above the transport unit in such a manner that it is supported so as to be variable perpendicularly relative to the transport plane. This allows the surface of the roller member to rest in a uniform manner on (or hover above) the material to be classified which is moved between the roller member and the transport device. At the same time, the roller can press on the material to be classified and thus distributes it on the transport belt. In place of a transport belt, it is possible to use, for example, an oscillating conveyor as the transport device.

To this end, the roller may be guided with an associated shaft on corresponding bearings which are constructed in a resilient manner; it is also possible to support the roller on or against shock-absorbers, which allow the desired movability of the roller member relative to the transport belt.

It is also possible to support the roller member so as to oscillate. In any case, a floating arrangement is desired, which allows a movement of the closure unit depending on the type, size and quantity of the material to be classified.

In the embodiment which is also set out in the description of the Figures below, the closure member is constructed as a roller which is arranged in a correspondingly formed opening of a supply channel for the material to be classified. In a similar manner, the closure member may also be positioned upstream of the channel-like portion.

In a configuration as a roller, the length of the roller is intended to be selected to the greatest possible extent in accordance with the width of the transport path or the width of the channel-like portion in order to minimise the cross-section within the channel-like portion. Consequently, the cross-section surface-area for supplying external air is also minimised.

In this context, attempts are also made to provide an assembly which is as fluid-tight as possible between the housing of the channel-like portion and the closure unit. Owing to the movability of the closure unit, it is not possible to achieve complete sealing. However, owing to a corresponding shaping of the housing (channel-like portion) and closure unit, free spaces for the intake of external air are minimised.

The closure member may also be configured in the manner of a continuous conveyor belt. This conveyor belt then extends more or less parallel and with spacing above the transport unit for the material to be classified, but in such a manner that the conveyor belt rests with at least a portion on the material which is introduced. In contrast to the transport unit, the conveyor belt can be moved at least partially perpendicularly relative to the transport direction of the material to be classified in order, as described above, to be able to bypass material to be classified of different sizes or to be able to rest thereon. The conveyor belt has the advantage of sealing the space between the transport unit and the housing of the channel-like portion to the greatest possible extent. Consequently, the cross-section surface-area for supplying secondary air is minimised accordingly. The conveyor belt may also be arranged relative to the transport unit in such a manner that a guiding path for the material to be classified tapers in the transport direction of the material.

In the same manner as other configurations of the closure unit, the conveyor belt may be constructed so as to have, on the surface thereof, freely protruding webs which extend transversely relative to the transport direction and in the direction towards the material to be classified. In a similar manner to a “rotary feeder”, these transverse webs allow additional sealing of the free space within the channel-like supply portion for the material to be classified. At the same time, the transverse webs provide guiding for the material to be classified.

The closure unit can be carried by means of friction as long as it is movable (rotatable); it can also be driven in a motorised manner, for example, in a synchronous manner relative to the transport unit.

Further features of the invention will be appreciated from the features of the dependent claims and the other application documentation.

### BRIEF DESCRIPTION OF THE DRAWINGS

The invention is explained in greater detail below with reference to two embodiments which are each highly schematic illustrations, in which.

FIG. 1 is a longitudinal section through a portion of a gravity separator; and

FIG. 2 is a longitudinal section through an introduction region of a gravity separator.

### DETAILED DESCRIPTION OF PREFERRED EMBODIMENT

In the Figures, components which are identical or which have the same function are illustrated with the same reference numerals.

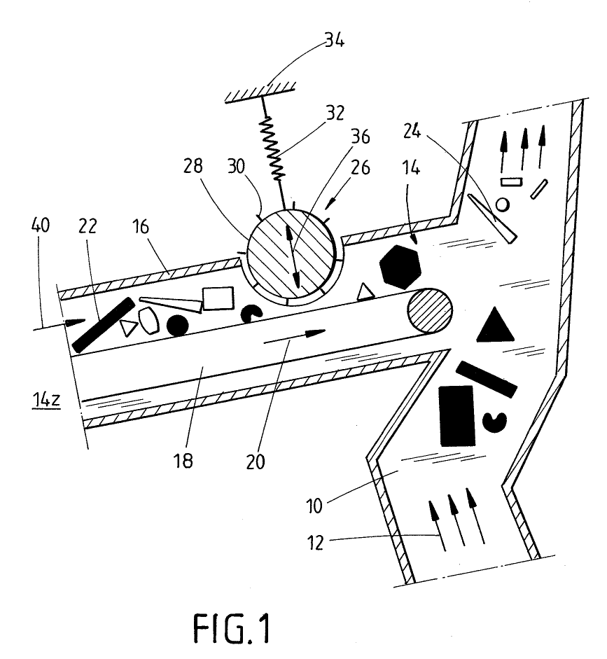

FIG. 1 illustrates an up-current separator whose classification chamber is designated 10. Air flows through the classification chamber 10 in the direction of arrow 12. In the classification chamber 10, a channel-like portion 14 opens at the side and, perpendicular relative to the plane of projection, has a substantially rectangular cross-section. A transport belt 18 extends in the channel-like portion 14 whose housing is designated 16 and a material to be classified (in this instance mixed waste) is conveyed on it from a feeding end 14z in the direction of arrow 20. This mixture of material contains components of different sizes, different weights, different shapes and different materials. For the purposes of illustration, in a highly schematic manner, heavy components are illustrated in black and designated 22, whilst lighter components are illustrated in white and are designated 24. This division corresponds to the classification in the classification chamber 10, heavy components 22 being discharged downwards from the classification chamber counter to the air flow 12, whilst lighter components 24 are discharged upwards by the air flow 12.

Above the transport belt 18, a closure unit 26 is illustrated and in this instance is in the form of a roller so that a circular or annular form is produced in vertical section. A roller member of steel is designated 28. From the surface thereof, webs 30 protrude in a radial direction and extend over the entire axial length of the roller 26. The shaft (not illustrated) of the roller 26 is suspended at the ends on springs which are designated 32 and which are in turn secured to a frame 34. The resilient force is adjusted in such a manner that the roller 26 can be moved in the direction of the arrow 36, depending on the quantity and size and density of the material which is conveyed along on the transport belt 18 below the roller 26. At the same time, it is ensured that the roller member 28 in each case is in contact with the material 22, 24 to be classified and consequently only the cross-section of the channel-like portion 14 that is absolutely necessary is kept clear so that the intake of secondary air, indicated with the arrow 40, is minimised.

In this context, the webs 30 also contribute to a reduction of the open cross-section of the channel-like portion 14. In place of a resilient device 32, shock-absorbers, oscillating bearings or the like may also be used to secure and guide the closure unit (roller) 26.

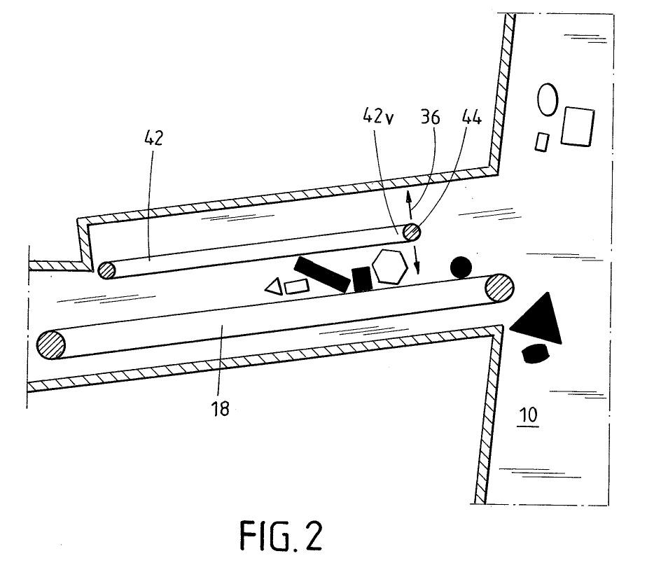

FIG. 2 illustrates another example of a closure unit, in this instance in the form of a conveyor belt 42 which extends in principle parallel with the transport belt 18. However, the front end 42v in the transport direction is guided in a floating manner, that is to say, the redirecting roller 44 can be moved in the direction of the arrow 36. The gap between the conveyor belt 42 and the transport belt 18 is thereby limited to the technically necessary extent depending on which material to be classified is moved in each case between the conveyor belt 42 and the transport belt 18.

Alternatively and/or in addition, the opposing end of the transport belt may also be constructed so as to be movable. In FIG. 2 the classification chamber 10 is only indicated.

1. Gravity separator having the following features:
1.1 a channel-like portion (14) having a transport unit (18), along which a material (22, 24) to be classified can be conveyed from a feeding end (14z) to a classification chamber (10),
1.2 a closure unit (26) which is arranged on and/or in the channel-like portion (14),
1.3 the closure unit (26) can be moved perpendicularly relative to the transport direction (20) of the material (22, 24) to be classified and is arranged in such a manner that it rests on the material which is transported through with at least a portion.

2. Gravity separator according to claim 1, wherein the closure unit (26) rolls on the material which is transported through.

3. Gravity separator according to claim 1, the closure unit (26) of which comprises a roller-like member (28).

4. Gravity separator according to claim 1, the closure unit (26) of which is arranged at the feeding end (14z) of the channel-like portion (14) and the feeding end (14z) is configured so as to correspond to the shape of the closure unit (26).

5. Gravity separator according to claim 1, the closure unit (26) of which comprises a continuous conveyor belt (42).

6. Gravity separator according to claim 1, the conveyor belt (42) of which, together with the transport device (18), forms a guiding path for the material (22, 24) to be classified which tapers in the transport direction (20) of the material.

7. Gravity separator according to claim 1, the closure unit (26) of which is supported at least in portions in a floating manner.

8. Gravity separator according to claim 1, the closure unit (26) of which is supported so as to oscillate at least in portions.

9. Gravity separator according to claim 1, the closure unit (26) of which is constructed so as to have, on the surface thereof, freely protruding webs (30) which extend transversely relative to the transport direction and in the direction towards the material (22, 24) to be classified.

10. Gravity separator according to claim 1, the transport direction (20) of which comprises a transport belt.

11. Gravity separator according to claim 1, the closure unit (26) of which is driven in a motorised manner.

12. Gravity separator according to claim 1, the closure unit (26) of which is composed of steel.
